(19) United States
(12) Patent Application Publication
(10) Pub. No.: US 2009/0138711 A1
(43) Pub. Date: May 28, 2009

(54) Sender Email Address Verification Using Reachback

(76) Inventor: Dennis Heimbigner, Boulder, CO (US)

Correspondence Address: LATHROP & GAGE LLP, 4845 PEARL EAST CIRCLE, SUITE 201, BOULDER, CO, 80301, US

(21) Appl. No.: 12/276,092

(22) Filed: Nov. 21, 2008

Related U.S. Application Data
(60) Provisional application No. 60/989,672, filed on Nov. 21, 2007.

(51) Int. Cl. H04L 9/32; G06F 15/16

(52) U.S. Cl. 713/170; 709/206; 713/176

(57) ABSTRACT

A Reachback email system includes methods and software products for intercepting a sent email message from an email client, algorithmically determining a first Reachback URL from an email address of the email client, adding the first Reachback URL to the sent email message to form a sent Reachback email message, digitally signing the sent Reachback email message, sending the sent Reachback email message to at least one recipient, publishing Reachback validation information (RVI) accessible by the at least one recipient using the first Reachback URL, intercepting a received Reachback email message before delivery to the email client, retrieving RVI for the received Reachback email message using a Reachback URL, validating the RVI, the Reachback URL and the Reachback email message contents, providing an indication of the Reachback email message validation, and delivering the received Reachback email message to the email client.

### RELATED APPLICATIONS

This application claims priority to U.S. Provisional Patent Application No. 60/989,672, entitled “Fine Grain Spam Suppression Using Reachback,” filed Nov. 21, 2007, the entire contents and disclosure of which is hereby incorporated by reference.

### BACKGROUND

Spam email (spam for short) is an unsolicited email message that has been sent indiscriminately to massive numbers of users (recipients). Despite major efforts to suppress spam email, the distribution of spam continues to plague email users. Estimates vary, but there is some consensus that 60-80% of all email is now spam email. This represents a tremendous burden on users.

To date, there are three primary approaches for suppressing spam: content filters, whitelisting and blacklisting. Content filters, such as SpamAssassin, are the most common approach for suppressing spam. A content filter examines each email message and, based on its content, the filter estimates the probability that the email is spam. Another approach is called “whitelisting.” A whitelist is a set of addresses that the receiver believes to be non-spam sources. Any email from a site on the whitelist is accepted and all others are rejected. The other common approach is called “blacklisting,” which is essentially the complement of whitelisting. A blacklist is a set of email addresses that are believed to be sources of spam email. Blacklists and whitelists may be used in combination. As a rule, a whitelist for an individual user is much smaller than a blacklist. Therefore, it is more efficient to test a received email address first against the whitelist, then, if the email address is on the whitelist, there is no need to perform the more costly blacklist check.

Blacklisting and whitelisting depend critically on the ability to accurately identify the true source of an email message. Unfortunately, it is easy for a spammer to forge (“spoof”) the source address in the ‘From’ header of an email message. This allows the spammer to send email with a fake source address that is not in the blacklist, and therefore will not be caught by the spam filter. Without being able to verify the sender's email address, it becomes very difficult to suppress spam reliably.

### SUMMARY OF THE INVENTION

A novel mechanism for accurately identifying the true source of a received email message is disclosed. Information is added to each email message to provide access to a source of validation information that produces evidence of the true source of the email address that cannot be forged. This new method (and associated infrastructure) is referred to hereinafter as “Reachback.” A Reachback system computes verification information about each sent email. The original message is augmented with a special “Reachback” header containing a URL (Uniform Resource Locator), hereinafter “Reachback URL”. This Reachback URL identifies a Reachback server that contains validation information for verifying the email message, and in particular, the ‘From’ address of the email message. The combination of Reachback server, of its internet IP address, and of the validation information allows a recipient of the email message to reliably infer a connection from the email message to the Reachback URL, then to the Reachback server, and finally to the email sender.

In an embodiment, a method generates a Reachback email message. An email message addressed to at least one recipient from a sender is intercepted. A Reachback URL based upon email address of the sender is algorithmically determined and Reachback validation information (RVI) is generated for the email message. The RVI is published at a location addressed by the Reachback URL, and the Reachback URL is added to the email message to form the Reachback email message. The Reachback email message is digitally signed using a private key of a public/private key pair, and the Reachback email message is sent to the at least one recipient.

In another embodiment, a method validates a Reachback email message. The Reachback email message is intercepted prior to delivery to an email client of a recipient of the Reachback email message. Reachback validation information (RVI) is retrieved, based upon a Reachback URL included within the Reachback email message. The RVI includes a public key of a public/private key pair, a sender email address of the Reachback email message, and a digital signature of the RVI. The RVI is validated based upon the digital signature of the RVI and the public key. If the RVI is valid, the Reachback URL is algorithmically validated using the sender email address. If the RVI and the Reachback URL are valid, the Reachback email message contents are validated based upon a content digital signature within the Reachback email message and the public key. A valid indication is stored in the Reachback email message if the RVI, the Reachback URL and the Reachback email message contents are valid, and a non-validated indication is stored in the Reachback email message if any one of the RVI, the Reachback URL and the Reachback email message contents are not valid.

In another embodiment, a system generates a Reachback email message, and includes a Reachback proxy for intercepting an email message from a sender, the Reachback proxy algorithmically determining a Reachback URL from an email address of the sender, adding the Reachback URL to the email message to form the Reachback email message, digitally signing the Reachback email message using a private key of a public/private key pair, and sending the Reachback email message to at least one recipient, and a server for publishing Reachback validation information (RVI) at a location addressed by the Reachback URL, the RVI comprising a public key of the public/private key pair, a Reachback sender email address, and a digital signature of the RVI.

In another embodiment, a system verifies a Reachback URL of a Reachback email message, and includes a server for publishing Reachback validation information (RVI) on a website addressed by the Reachback URL, the RVI comprising a public key of a public/private key pair, a Reachback sender email address, and a digital signature, and a validation proxy for intercepting the Reachback email message before delivery to at least one email client, the validation proxy retrieving the RVI from the website and decoding the digital signature using the public key to validate the RVI and then algorithmically validating the Reachback sender email address to the Reachback URL to determine validity of the Reachback sender email address, the validation proxy storing the Reachback sender email address and a validated indication in the Reachback email message to form a validated Reachback email message if the Reachback sender email address is valid, otherwise storing a non-validated indication in the validated Reachback email message, the validation proxy then sending the validated Reachback email message to the at least one email client.

In another embodiment, a Reachback email system, includes (a) a Reachback proxy for intercepting a sent email message from an email client, the Reachback proxy algorithmically determining a first Reachback URL from an email address of the email client, adding the first Reachback URL to the sent email message to form a sent Reachback email message, digitally signing the sent Reachback email message using a private key of a public/private key pair, and sending the sent Reachback email message to at least one recipient, (b) a server for publishing Reachback validation information (RVI) accessible by the at least one recipient using the first Reachback URL, the RVI comprising a public key of the public/private key pair, the email address, and a digital signature of the RVI generated using the private key, and (c) a validation proxy for intercepting a received Reachback email message before delivery to the email client, the validation proxy retrieving RVI for the received Reachback email message using a second Reachback URL stored within the received Reachback email message, decoding a digital signature of the RVI using a public key stored in the RVI to validate the RVI, and then algorithmically validating the second Reachback URL with an email address of the RVI, the validation proxy providing an indication of the Reachback email message validation and delivering the received Reachback email message to the email client.

In another embodiment, an email validation system includes means for algorithmically determining, at a first location, a Reachback URL for an email message sent to at least one recipient, means for adding, at the first location, the Reachback URL to the email message and digitally signing the email message content, means for publishing, at the first location, Reachback validation information (RVI) accessible by the at least one recipient based upon the Reachback URL, means for retrieving, at a second location, the RVI based upon the Reachback URL stored in the email message, means for validating the RVI, the email message content, and the Reachback URL, and means for indicating a validation status of the email message.

In another embodiment, a software product has instructions, stored on computer-readable media, wherein the instructions, when executed by a computer, perform steps for sending and receiving validated email messages, including instructions for algorithmically determining, at a first location, a Reachback URL for an email message sent to at least one recipient, instructions for adding, at the first location, the Reachback URL to the email message and digitally signing the email message content, instructions for publishing, at the first location, Reachback validation information (RVI) accessible by the at least one recipient based upon the Reachback URL, instructions for retrieving, at a second location, the RVI based upon the Reachback URL stored in the email message, instructions for validating the RVI, the email message content, and the Reachback URL, and instructions for indicating a validation status of the email message.

### BRIEF DESCRIPTION OF THE FIGURES

FIG. 1 shows one exemplary email communication system that uses Reachback to verify a sender email address of an email message, in an embodiment.

FIG. 2 shows one exemplary email communication system illustrating the use of Reachback for ‘fine grain’ spam suppression, in an embodiment.

FIG. 3 shows one exemplary implementation where a Reachback proxy is located between an email sender and a mail transfer agent, in an embodiment.

FIG. 4 shows one exemplary implementation where a validation proxy is located between a POP3 or IMAP server and an email receiver, in an embodiment.

FIG. 5 shows one exemplary process for generating Reachback email messages, in an embodiment.

FIG. 6 is a flowchart illustrating one exemplary process for intercepting and validating Reachback email messages, in an embodiment.

### DETAILED DESCRIPTION OF THE FIGURES

The use of Reachback for validating a sender email address of a Reachback email message has several advantages compared to existing approaches for validating email messages. Reachback does not use the Domain Name System (DNS) to store validation information, and it can be used both with blacklisting and with an automated whitelist. Reachback does not require a specific type of server to provide Reachback validation information and may delegate the validation information to servers outside of the sender's domain. Because it validates the sender's email address, it can support very fine grain validation down to the level of each individual email addresses. It also has the option to use simple secret keys rather than public/private pairs by transferring the decryption burden to the Reachback server.

DNS-based spam filtering that requires site-wide implementation, such that incremental adoption of this Spam filtering approach by individual users is effectively impossible. The use of Reachback allows incremental adoption which is a significant advantage over DNS-based spam filtering.

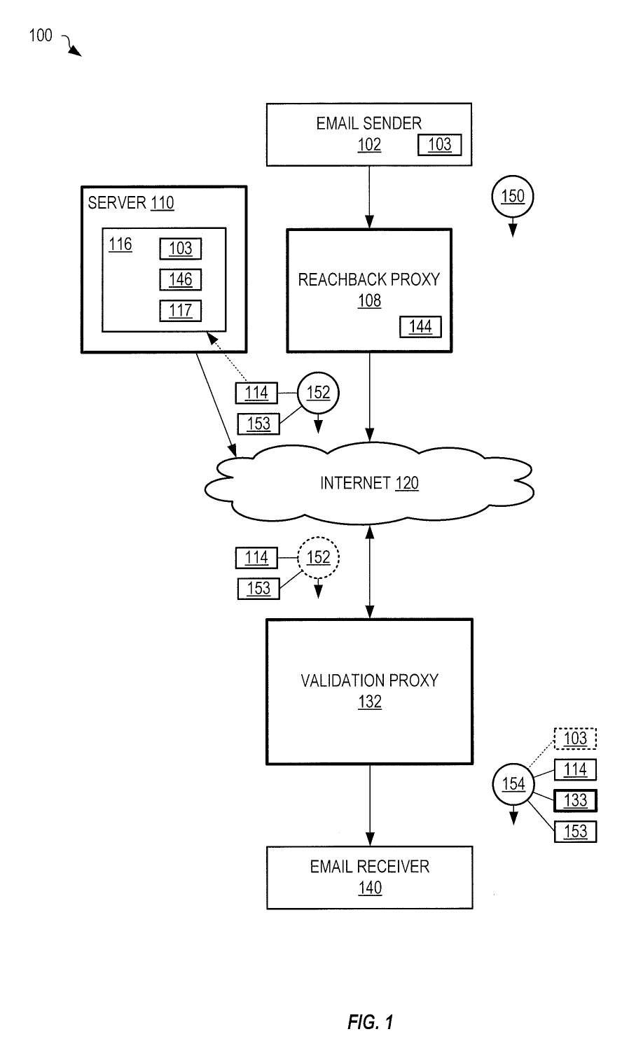

FIG. 1 shows one exemplary email communication system 100 that uses Reachback to verify a sender email address of an email message. An email sender 102 generates an email message 150 that is addressed to an email receiver 140. A Reachback proxy 108 intercepts email message 150 before it is sent out over the Internet 120. Reachback proxy 108 generates a Reachback URL based upon an email address of email sender 102, generates a digital signature 153 of email message 150 and Reachback URL 114 using a private key 144 of a public/private key pair, and adds Reachback URL 114 and the digital signature to email message 150, shown as a Reachback email message 152 in FIG. 1. Where Reachback verification information (RVI) 116 associated with email sender 102 does not already exist, Reachback proxy 108 creates RVI 116 containing an email address 103 of email sender 102, a public key 146 that is part of public/private key pair 142, and a digital signature 117, generated using private key 144, of Reachback URL 114 and public key 146. Reachback proxy 108 then publishes RVI 116 on a server 110 that is accessible from Internet 120. Reachback proxy 108 then sends Reachback email message 152, via Internet 120, for delivery to email receiver 140.

A validation proxy 132, located at an email site of email receiver 140, intercepts Reachback email message 152 prior to its delivery to email receiver 140. Validation proxy 132 retrieves RVI 116 from server 110 based upon Reachback URL 114 of Reachback email message 152 and then validates RVI 116 using public key 146 and digital signature 117. If RVI 116 is valid, validation proxy 132 utilizes public key 146 to validate Reachback email message 152 based upon digital signature 153. If both RVI 116 and Reachback email message 152 are valid, validation proxy 132 utilizes an algorithm to validate email address 103 of email sender 102 to Reachback URL 114. If email address 103 and Reachback URL 114 validate to one another, email address 103 is verified to be of email sender 102. Validation proxy 132 may then add email address 103 and an email validity status 133 to Reachback email message 152, shown as a Reachback email message 154 in FIG. 1, to indicate the verified email address 103 of email sender 102 and whether Reachback email message 154 is valid.

Reachback proxy 108, server 110 and validation proxy 132 thereby cooperate to validate email address 103 of email sender 102 for email message 150, 152, 154. By verifying email address 103 of email sender 102, validation proxy 132 may further process Reachback URL 114 (or email address 103) against one or both of a white list and a blacklist to determine whether email message 150, 152, 154 is spam.

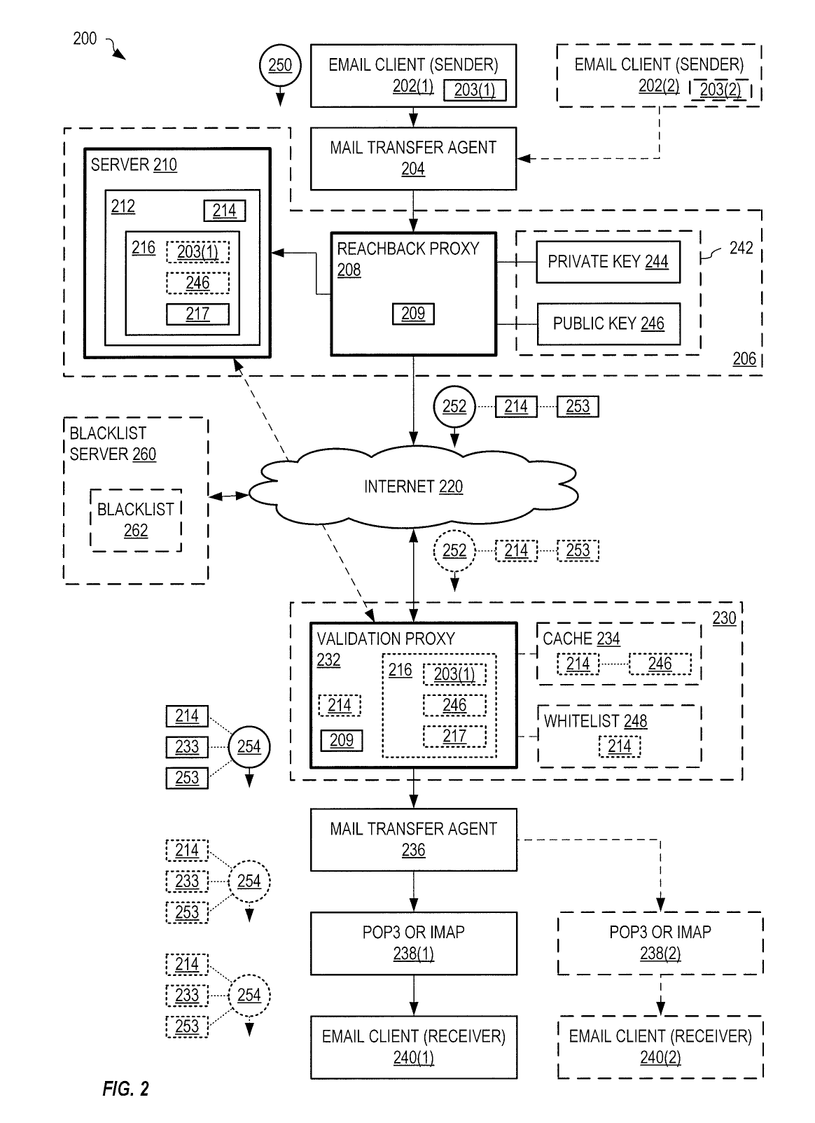

FIG. 2 shows one exemplary email communication system 200 illustrating the use of Reachback for ‘fine grain’ spam suppression. The term ‘fine grain’ is used to differentiate spam suppression using a full email address, as enabled by Reachback, from spam suppression using only a domain name, as typically used in the prior art.

In the example of FIG. 2, system 200 is shown with two email senders 202(1), 202(2) and two email receivers 240(1), 240(2). However, each email sender 202 and email receiver 240 may represent typical email clients (also known as mail user agents), each of which may both send and receive email messages. Email sender 202(1) sends an email message 250 to email receiver 240(1) via a mail transfer agent 204, a sender Reachback components 206, the Internet 220, receiver Reachback components 230, a mail transfer agent 236, and a POP3 or IMAP server 238(1). Email sender 202, mail transfer agent 204, Internet 220, mail transfer agent 236, POP3 or IMAP server 238 and email receiver 240 represent components typically found for supporting email services. It should be noted that mail transfer agents 204 and 236 may support multiple email servers and email clients without departing from the scope hereof. As way of illustration, a second POP3 or IMAP server 238(2) and a second email receiver 240(2) are shown connected to mail transfer agent 236.

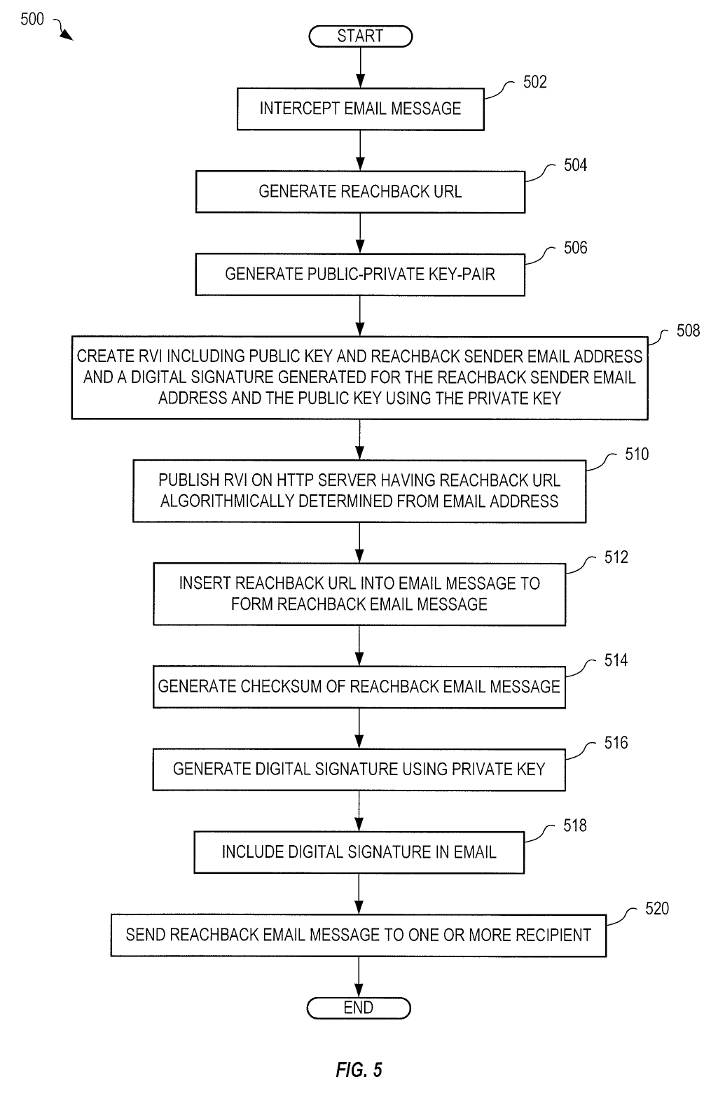

Upon understanding the configuration shown in FIG. 2, it should be apparent that without sender Reachback components 206 and receiver Reachback components 230, system 200 resembles a conventional email system; i.e., sender Reachback components 206 and receiver Reachback components 230 may be added to existing email systems to form email communication system 200 with Reachback. FIG. 5 shows one exemplary process 500 for generating Reachback email messages. Process 500 is implemented within Reachback proxy 208 of FIG. 2, for example. FIGS. 2 and 5 are best viewed together with the following description.

In step 502, process 500 intercepts an email messages and email message before it is sent out for delivery over the internet. In one example of step 502, a Reachback proxy 208 of sender Reachback components 206 intercepts email message 250 from mail transfer agent 204 before it is sent out over Internet 220. In step 504, process 500 generates a Reachback URL based upon the sender's email address. In one example of step 504, Reachback proxy 208 utilizes algorithm 209 to generate Reachback URL 214 from email address 203(1) stored within email message 250.

A URL is of the general form “http://domainname.tld/path”, where “domainname.tld” is the DNS name of a particular machine and “path” is a sequence of names separated by the forward slash character. For a given domain name prefix, the set of possible paths effectively forms a tree, the domain name prefix forming the root. Each specific path may identify an individual source. For example, where email address 203(1) of email sender 202(1) has a value of bob@domainname.tld, associated Reachback URL 214 may have a value of “http://domainname.tld/X/bob.” From Reachback URL 214, it is algorithmically possible to determine email address 203(1) and similarly, it is algorithmically possible to determine Reachback URL 214 from email address 203(1). In this example, the “X” represents an agreed upon name (e.g., a character string) that is applied to differentiate Bob's Reachback URL 214 from any existing URL Bob may already be using for a web page address. That is, by defining and using “X” consistently within an algorithm 209 (sown within Reachback proxy 208) that converts between an email address and a Reachback URL, conflicts between Reachback URLs and URLs of non-Reachback web sites may be avoided. Algorithm 209 may be implemented within Reachback proxy 208 and used to create Reachback URL 214 from email address 203(1).

Since email address 203(1) has an algorithmic (i.e., using algorithm 209) relationship to Reachback URL 214, spam blacklist systems may attribute the email source to a very fine degree, such that rather than blocking all of “domainname.tld” because Bob is sending spam, only Bob needs to be blocked, by applying and using Reachback URL 214 (e.g., http://domainname.tld/X/bob).

In step 506, process 500 generates a public/private key pair 242, for example, using a public/private key generator such as PGP, known in the art.

In step 508, process 500 generates RVI 216 to include three data items: (1) a public key 246 of public/private key pair 242; (2) email address 203(1), which is the email address of email sender 202(1); and (3) a digital signature 217, which is generated using a private key 244 of public/private key pair 242 and based upon the information in data items (1) and (2). Digital signature 217 may be used by other entities to ensure that data items (1) and (2) are secure (i.e., not modified or corrupted). For example, public key 246 of item (1) may be used to decrypt digital signature 217 such that the decrypted checksum of digital signature 217 may be compared to a checksum of items (1) and (2). If the checksums match, RVI 216 may be assumed to be valid.

Sender Reachback components 206 also include a server 210 (e.g., an HTTP server) that maintains a web page 212 at an address defined by Reachback URL 214 (i.e., web page 212, published by server 210 and is addressed using Reachback URL 214). In step 510, process 500 publishes RVI 216 on web page 212 of Server 210 such that RVI 216 may be accessed (e.g., via Internet 220) using Reachback URL 214 of Reachback email message 252.

Reachback proxy 208 may maintain a data structure of senders email addresses (e.g., email address 203(1)) and associated Reachback URLs (e.g. Reachback URL 214) and public/private key-pairs, such that the associated Reachback URL and public/private key-pair need not be generated for each email message. Further, where public/private key pair 242 is unchanged for a certain sender email address 203(1), RVI 216 need not be regenerated and published. That is, steps 504, 506, 508 and 510 may be omitted where RVI 216, Reachback URL 214 and public/private key pair 242 where they are already generated and no change is required. For a given email address, only one Reachback URL is possible, however, user and/or system policies may requires that public/private key pair 242 be renewed periodically, requiring that steps 506, 508 and 510 of process 500 be explicitly performed.

In step 512, process 500 inserts the Reachback URL of step 504 into the email message to form a Reachback email message. In one example of step 512, Reachback proxy 208 adds Reachback URL 214 to email message 250 (e.g., to a header of email message 250) to form a Reachback email message 252 for output, over Internet 220, to email receiver 240(1).

In step 514, process 500 generates a checksum of the content of the email message. In one example of step 514, Reachback proxy 208 generates a checksum of the content of email message 250. In step 516, process 500 generates a digital signature of the checksum using a private key. In one example of step 516, Reachback proxy 208 creates a digital signature 253 for email message 250 using the checksum and private key 244 of public/private key pair 242. In step 518, process 500 includes the digital signature in the email message. In one example of step 518, Reachback proxy 208 includes digital signature 253 within email message 250, which is illustratively shown as a Reachback email message 252 in FIG. 2. In one embodiment, digital signature 253 is included as a parameter in a Reachback header, that contains Reachback URL 214, added to form Reachback email message 252. In an alternate embodiment, digital signature 253 is placed at the end of Reachback email message 252 (i.e., at the end of the message body of Reachback email message 252).

In step 520, process 500 sends the Reachback email message to one or more recipients. In one example of step 520, Reachback proxy 208 sends Reachback email message 252 to Internet 220 for delivery to email receiver 240(1).

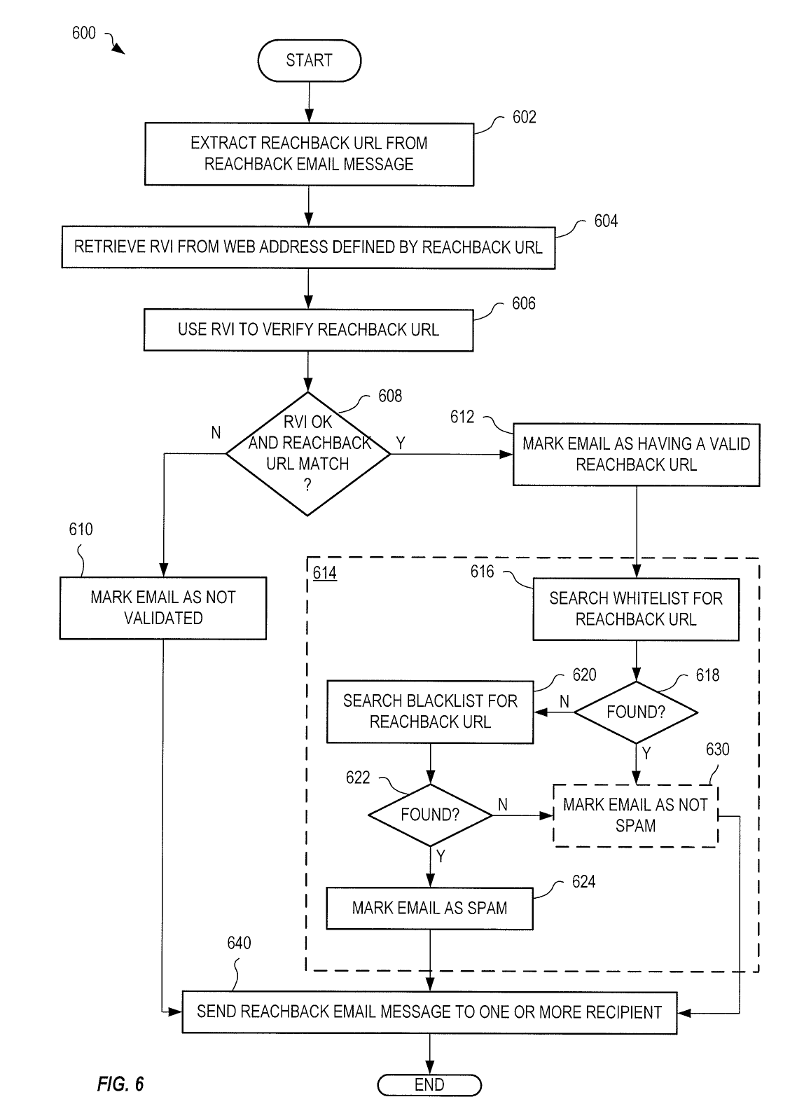

FIG. 6 is a flowchart illustrating one exemplary process 600 for intercepting and validating Reachback email messages. Process 600 is implemented within a validation proxy 232 of receiver Reachback components 230, for example. Validation proxy 232 may be configured to intercept email messages delivered to a mail transfer agent 236 from Internet 220. For example, where mail transfer agent 236 handles email messages for delivery to email receiver 240(1) and/or email receiver 240(2), these email messages are first intercepted by validation proxy 232.

Reachback email message 252 is a normal email that uses normal email transport mechanisms to navigate Internet 220 and email infrastructure. Reachback email message 252 may have traversed any number of sites and computers before arriving at receiver Reachback components 230. For example, Reachback email message 252 may have been forwarded, passed through a mail list, or even passed through an open email relay, as known in the art. That is, Reachback email message 252 may be handled in a like manner to regular email messages, known in the art.

In step 602, process 600 extracts a Reachback URL from an intercepted Reachback email message. In one example of step 602, validation proxy 232 extracts Reachback URL 214 from Reachback email message 252. In step 604, process 600 retrieves RVI from a web page addressed by the Reachback URL. In one example of step 604, validation proxy 232 utilizes Reachback URL 214 of Reachback email message 252 to access web page 212 and retrieve RVI 216 via Internet 220.

In step 606, process 600 validates the retrieved RVI, the digital signature of the email message and the Reachback URL. In one example of step 606, validation proxy 232 validates RVI 216 using public key 246 and digital signature 217 of RVI 216. Validation proxy 232 then validates digital signature 253 of Reachback email message 252 using public key 246 and check summing the content of Reachback email message 252. Validation proxy 232 then validates Reachback URL 214 against email address 203(1) of RVI 216 using algorithm 209.

Step 608 is a decision. If, in step 606, the RVI and the Reachback URL validated OK, then process 600 continues with step 612; otherwise process 600 continues with step 610. In step 610, process 600 marks the received email message as not validated. In one example of step 610, validation proxy 232 adds email validity status flag 233 to Reachback email message 252, illustratively shown as a Reachback email message 254, and marks email validity status flag 233 as not validated. For example, an email message sent from a non-Reachback sender would not include a Reachback URL and would therefore be marked as not validated. Alternatively, where an email message included a Reachback URL that did not algorithmically match the retrieved sender email address, the email would be marked as not validated. In an alternate embodiment, email messages having an included Reachback URL that did not algorithmically match the retrieved sender email address is marked as invalid, thereby distinguishing from email messages without Reachback URLs. In this later case, a receiving user's email client (e.g., email receiver 240) may be configured to handle these messages differently from those marked as not validated and those marked as valid. Process 600 then continues with step 640.

In step 612, process 600 marks the received email message as valid. In one example of step 612, validation proxy 232 adds email validity status flag 233 to Reachback email message 252, illustratively shown as Reachback email message 254, and marks email validity status flag 233 as valid. Optionally, process 600 continues with step 616 if an optional sub-process 614 is included; otherwise process 600 continues with step 640.

Optionally, the verified Reachback URL (or verified sender's email address 103(1)) may be evaluated against one or both of a whitelist and a blacklist, and the email message may be marked according to findings. Since the senders email address (and algorithmically verifiable Reachback URL) is validated (i.e., known to be correct), it is possible to compare either the senders email address or the Reachback URL to lists of known valid senders (whitelists) or lists of know spammers (blacklists).

In FIG. 6, optional spam analyzing sub-process 614 includes steps 616 through 630. In step 616, process 600 searches a whitelist of Reachback URLs of valid senders for the validated Reachback URL of the received Reachback email message. In an alternative embodiment, in step 616, process 600 searches a whitelist of email addresses of valid senders for the validated email address of the email message.

Step 618 is a decision. If, in step 618, process 600 determines that the validated Reachback URL (or sender's email address) is found in the whitelist, process 600 continues with step 630; otherwise process 600 continues with step 620. In step 620, process 600 searches a blacklist of Reachback URLs of known sources of spam. Step 622 is a decision. If, in step 622, process 600 determines that the Reachback URL is located within the blacklist, process 600 continues with step 612; otherwise process 600 continues with step 624. In step 624, process 600 marks the received Reachback email message as spam. In one example of step 624, validation proxy 232 marks email validity status flag 233 as spam. Process 600 continues with step 640.

Step 630 is optional. If included, in step 630, process 600 marks the received email message as not spam. Process 600 continues with step 640. In one example of step 630, email validity status 133 (containing one or more indications of the above verification results) is added to Reachback email message 152 to form Reachback email message 154.

In step 640, process 600 sends the Reachback email message to one or more recipients. In one example of step 640, validation proxy 232 sends Reachback email message 254 to email receiver 240(1) via mail transfer agent 136 and POP3 or IMAP server 238(1). Email receiver 140(1) may be configured to take appropriate action automatically for each received Reachback email message 254 based upon email validity status flag 233.

Unlike other approaches, Reachback proxy 208 and validation proxy 232 do not use information within a ‘From’ header of processed email messages (e.g., email messages 250 and 252). Within validation proxy 232, RVI 216, retrieved using Reachback URL 214 within Reachback email message 252, provides sufficient information to both identify the source of Reachback email message 252 and to verify that Reachback email message 252 came from that source.

### Validation Proxy Cache

Optionally, validation proxy 232 may utilize a cache 234 to reduce the cost of validation. As shown in FIG. 2, cache 234 is in communication with validation proxy 232 and associates Reachback URL 214 with RVI 216 (or at least a corresponding public key 246 of RVI 216, as shown). In one example of operation, upon receipt of Reachback email message 252, validating proxy 232 first searches cache 234 for Reachback URL 214 (of Reachback email message 252) and, if found, validation proxy 232 attempts to validate Reachback email message 252 using the associated public key 246 from cache 234. If validation proxy 232 does not find Reachback URL 214 not found within cache 234, or if found but the associated public key 246 does not validate Reachback email message 252, then validation proxy 232 retrieves RVI 216 from Server 210. Validation proxy 232 may then store Reachback URL 214 and public key 246 within cache 234 for subsequent use, and performs the validation of Reachback email message 252 as described above.

In one example of operation, since cache 234 is probably implemented as a fixed size, a least-recently-used (LRU) replacement policy may be implemented to manage storage of Reachback URLs and associated public keys; however, other policies may be implemented based upon semantic knowledge without departing from the scope hereof. In another example, validation proxy 232 may also maintain a whitelist of Reachback URLs of valid email senders that should never be replaced.

Alternate Reachback Configurations

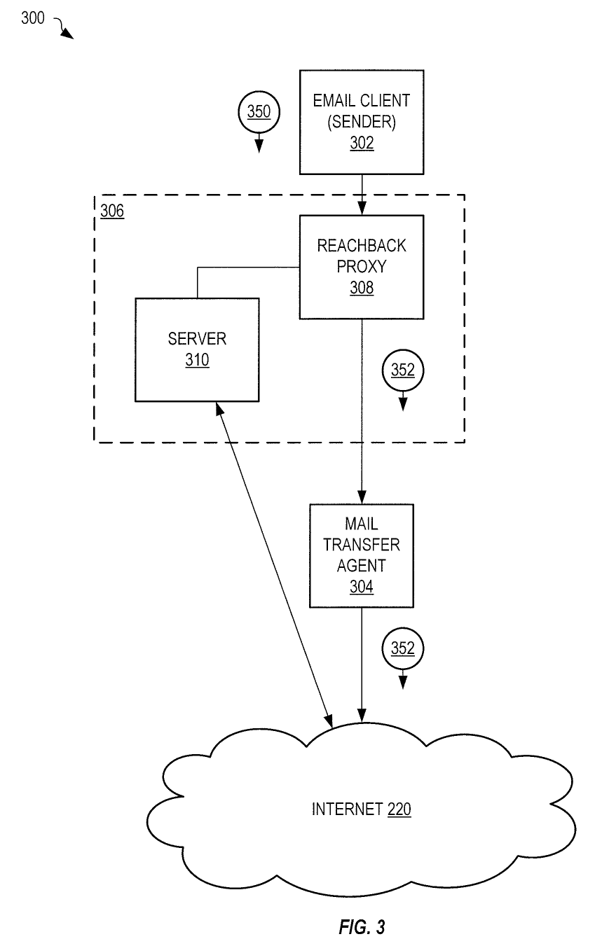

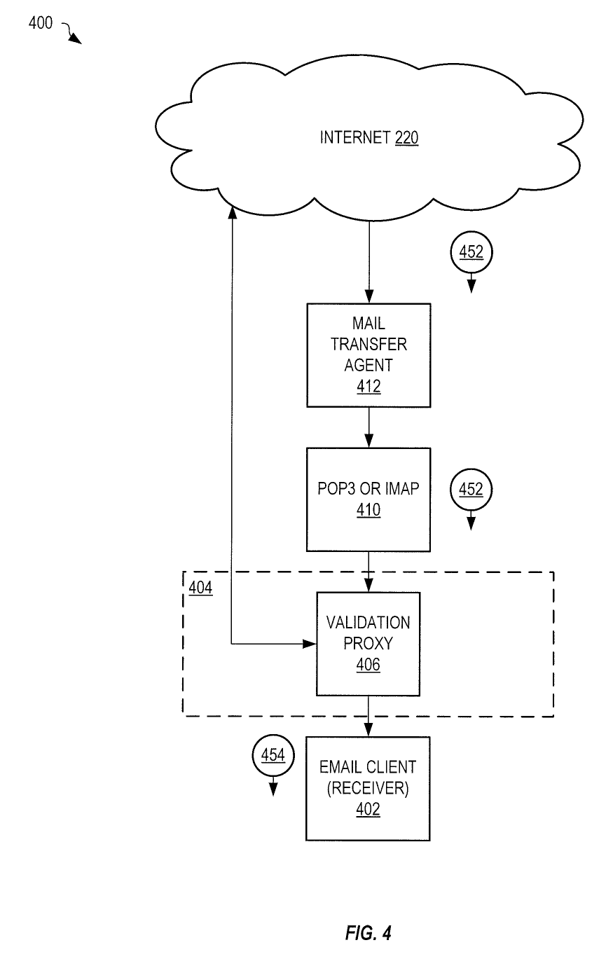

Positioning of sender Reachback components 206 to intercept email messages sent from mail transfer agent 204 to Internet 220 for delivery, and positioning of receiver Reachback components 230 to intercept email messages from Internet 220 to mail transfer agent 236, as shown in FIG. 2, is preferred. Validation proxy 232 may act as an SMTP proxy that receives all incoming email messages (e.g., Reachback email message 252) for a certain site, validates the email messages, and passes them on (e.g., as Reachback email message 154) to mail transfer agent 236 (e.g., Postfix) for delivery by POP3 or IMAP servers 238 to one or more designated (within the header or each email message) email receiver 240. However, without departing from the scope hereof, alternative configurations are possible, as shown in FIGS. 3 and 4, and described below.

FIG. 3 shows one exemplary implementation 300 where sender Reachback components 306 are located between an email sender 302 and a mail transfer agent 304. Sender Reachback components 306 include a Reachback proxy 308 and an Server 310. Reachback proxy 308 operates similar to Reachback proxy 108 of FIG. 1 and Reachback proxy 208 of FIG. 2 to certify the source of an email message 350 using Server 310.

It is also possible to merge Reachback proxy 308 with email sender 302 and mail transfer agent 304 (which is typically an SMTP server). It may be preferable to merge Reachback proxy 308 with mail transfer agent 304 because it allows the insertion of a Reachback URL into all email messages, including automatically generated emails (e.g., email messages indicating error conditions). Alternatively, when Reachback proxy 308 is merged with email sender 302, email messages automatically generated by mail transfer agent 304 will not include Reachback URLs. Server 310 may also be merged with mail transfer agent 304, since mail transfer agent 304 is already accessible from Internet 220 and may easily export an HTTP server interface. Merging of Server 310 with mail transfer agent 304 is unlikely, however, because web servers are generally available, but may be useful if other key signing protocols are used.

FIG. 4 shows one exemplary implementation 400 where receiver Reachback components 404 are located between POP3 or IMAP server 410 and email receiver 402. A validation proxy 406 of receiver Reachback components 404 may implement a wrapper for POP3 or IMAP server 410 to perform validation. Email receiver 402 points to the wrapper and the wrapper in turn points to POP3 or IMAP server 410. Commands from email receiver 402 are passed transparently to POP3 or IMAP server 410 server, and validation is applied to email messages (e.g., an email message 452) by validation proxy 406. Implementation 400 may represent Reachback use with the Unix Procmail system, which is per-user. It is also possible to place receiver Reachback components 404 between Postfix and a POP3 server, but this may be more complex because these two programs usually communicate through the file system (e.g., using Maildir format) as opposed to using TCP/IP.

Implementation 400 may be desirable and more easily implemented for POP3 servers. IMAP servers, however, are so complex that the validation is more complex. Merging validation proxy 406 with email receiver 402 has the advantage of supporting incremental adoption as a per-user solution.

Whatever the placement, the Reachback proxy (e.g., Reachback proxy 108, FIG. 1 and Reachback proxy 208, FIG. 2, and Reachback proxy 308, FIG. 3) constructs RVI 216 and digital signature 253 from the message contents and private key 244. RVI 216 is made available to recipients of Reachback email message 252 at a web address defined by Reachback URL 214. Servers 210 and 310, FIGS. 2 and 3 respectively, may represent any type of server, such as HTTP servers, that make RVI (e.g., RVI 216) available to email recipients.

Reachback For Automatic Whitelists

In an embodiment, validation proxy 232 automatically maintains whitelist 248 to contain Reachback URLs of valid email senders. Where a group of email users mutually adopt Reachback, that group is immediately guaranteed that members of the group are not spammers (or will be suppressed if they are, since the source Reachback URL of the spam source will be known). The advantage provided by Reachback over traditional whitelists is that the set of acceptable senders stored in the whitelist may grow without action by the user, since verification proxy 232 adds Reachback URLs of all validated email messages to whitelist 248. This is a big advantage in certain institutions such as Universities since personnel of the University may be characterized as a rapidly changing population. Within Universities, Reachback implementation is also relatively easy because email transmission is often a centralized function and because most University personnel each have a defined web page. The automatic maintenance of whitelist 248 also provides an incentive to adopt Reachback, since each user that adopts Reachback is automatically added to the group of accepted users.

The Reachback Server

It is possible to associate the source of the RVI to the sender of the email. This allows a recipient to infer a connection from the email message to the Reachback URL, then to a Reachback server, and finally to the email sender. Any server that may be accessed by some well-known URL protocol may be used as the server for Reachback information. The simplest form of information source is an HTTP server (e.g., server 110, FIG. 1 and server 210, FIG. 2) that is trusted by the sender and is located in the same domain as the sender. The Reachback information is placed at a well-known (i.e., pre-defined) location under the sender's web page.

Costs

Reachback is not without cost, since it requires resources from each site that sends or receives email using Reachback. The sending site is to support a server that allows email recipients to access RVI associated with email messages that it distributes. For a certain period, the sending site is to store the RVI and allow recipients to validate the email message content. The sending site bears the cost of computing the RVI and public/private key pairs. The receiver of Reachback email messages bears the cost of validating these messages, and may bear the cost of caching Reachback information. However, none of these costs is especially onerous.

Additional Issues

There are a number of lesser, but still important issues that is to be addressed with respect to the practical use of Reachback.

Idempotence

Validation for each message is done once on the sender side and once on the receiving side. However, where Reachback is initially implemented by individual users and later deployed site-wide, an email message sent from the site may be processed by a plurality of Reachback proxies (e.g., Reachback proxy 208, FIG. 2), resulting in a plurality of Reachback URLs being added to the email message. Similarly, a received email may pass through a plurality of validation proxies (e.g., validation proxy 232), resulting in multiple validations. It is therefore desirable that Reachback be idempotent so that each proxy validates correctly. Although, processing of a message by the plurality of Reachback proxies may result in a plurality of Reachback URLs being added to the email message, no obvious problem arises because each added URL may access a different public key, any one of which may be used for validation, although the initial Reachback URL and associated RVI is the most valuable since it indicates the true sender of the email message.

One solution is for each Reachback proxy (e.g., Reachback proxy 108) to recognize an email message that has already been processed by another Reachback proxy (e.g., recognize the Reachback URL header) and just pass the email message on without further processing, since the original Reachback URL specifies the true and original sender email address (e.g., email address 203) of the email message. In another solution, where multiple Reachback URLs are added to an email message, each Reachback URL may be validated, successively, until all are checked. A first validation proxy, after validating each of the Reachback URLs, may rewrite the Reachback header to flag the fact that it has performed the validation, such that subsequent validation proxies need only check this flag within the Reachback header. However, this does allow a potential attack where a spam sender formats an email message to look like it already has been validated, but specifies a fake source. One possible solution to this attack scenario is to “trust but verify.” That is, each validation proxy re-validates each of the Reachback URLs. Although this approach may introduce some overhead in the short term, this overhead disappears once the downstream validation proxies are removed, leaving only a single primary validation proxy.

Forwarding

Forwarding of a received email message by one or more of many types of relay and/or email proxy, may result in that email message passing through multiple Reachback proxies. Each Reachback proxy may add a new Reachback header (containing its Reachback URL) to the email message before re-sending the message to the forwarding destination. Prior art systems utilize the “From” header of the email message to determine which DNS entry to check. In contrast, since Reachback does not utilize the “From” header of the email message, Reachback is unaffected by email message forwarding.

Mail Lists and Mail Digests

Mail lists operate by collecting email messages from multiple senders and re-sending them to their subscribers. Digests are similar except that they will send out a single message that aggregates a number of submitted emails. There are four possible combinations of interactions between Reachback and mail lists depending on whether or not the email sender and the mail list site utilizes Reachback. (a) Where the sender and the mail list do not use Reachback, there is no effect. (b) Where the sender uses Reachback and the mail list does not, the messages that are redistributed by the mail list will contain the Reachback URL pointing to the original validation information. (c) Where the sender does not use Reachback and the mail list does use Reachback, the redistributed messages will contain a Reachback URL of the mail list site such that the message validation source will be the mail list site. (d) Where both the sender and the mail list use Reachback, the idempotence argument described above may apply, and the scenario may be treated the same as case (b).

Incremental Adoption

It is clear from the experience of the Internet community that adoption of any anti-spam system will be a protracted process. It is therefore important that the anti-spam system have the ability to be incrementally adopted with minimal disruption and with the ability to work with existing email clients and other email infrastructure.

As described above, and shown in FIGS. 3 and 4, Reachback may be adopted at an individual level and at a site level. Senders and receivers may adopt Reachback transparently; the only visible sign is the inclusion of the Reachback URL in the email message (e.g., in the email message header). Where a true source address of an email message cannot be verified (e.g., the email sender does not support Reachback), the email message cannot effectively be tested against a blacklist. Therefore, it is undesirable to discriminate against such email until email message source verification is adopted widely. For example, with Reachback, the source of email messages that have no associated Reachback URL cannot be verified. In the short term, the only solution for protecting against spam for such email messages is to rely upon conventional spam filtering. However, as discussed above, incremental adoption of Reachback still provides value to users even in the absence of widespread Reachback adoption, because an automatic whitelisting capability is supported that is useful even in the absence of effective blacklisting.

Potential Attack Scenarios

It is difficult to guarantee that a given anti-spam system, such a Reachback, is secure against attacks. Attackers (spammers) are resourceful and may utilize attacks not considered by the developer. This following description considers some possible attack scenarios and how they are addressed through Reachback.

Address Spoofing

A spammer's main method for spoofing email header addresses is to use one or more of: zombies, open proxies, open mail relays, and transient internet connections. The last three cause no particular problem because Reachback does not use the “From” header or any other header except the Reachback URL. This means that forwarding through additional sites has no effect. The zombie issue is, however, of concern and is addressed specifically below. Another possible address spoofing attack available to a spammer is to deliberately use a fake Reachback URL. Obviously using a completely fake URL will fail because no useful validation information would be available to a validation proxy. Further, where functional RVI is provided, unless the spammers Reachback URL and spoofed email address are algorithmically determinable from one another, the validation fails. Where the Reachback URL and the spoofed email address are algorithmically determinable, the spoofed email address is probably traceable back to the spammer's Reachback server.

HTTP Server Spoofing

A spammer may set up a dummy HTTP server that is used to return the same RVI for all Reachback URLs that access it. The spammer then inserts a fake Reachback URL, based on that RVI, into the email message and sends it out. The validation proxy will then validate the received email message using that RVI. This kind of spoofing will not work for very long because that HTTP server site will rapidly be tagged as a spam source, since the Reachback URL of the HTTP server site is contained within the RVI. The spammer may also attempt to set up a large number of HTTP servers, but as discussed below this will become prohibitively expensive. Another possible attack is to set up a server that pretends to provide validation information for a specific sender's email address. This can work only if the spammer is in the same domain as the true sender and has access to the sender's web pages. Serving information from any other site will fail because the algorithmic validation of the Reachback URL to the sender's email address will fail. In this scenario, the spammer has essentially compromised the whole site (domain), and should therefore be suppressed by administrative mechanisms at the site.

In a less obvious attack, a spammer sends out email containing a special URL with the intent of getting the recipient's validation proxy to access it. Historically, certain browsers have had implementation flaws that allow a browsing computer to become compromised by just accessing (visiting) certain web sites. Usually this occurs because the accessed web server delivers unexpected content that causes code execution on browsing computer. Such attacks may be prevented by accessing each Reachback server (e.g., server 210, FIG. 2) without using any web-browser components. Thus, each validation proxy (e.g., validation proxy 232) is constructed to enforce the use of a simplified protocol (e.g., HTTP) by the server and thus suppress any unexpected content that is returned by the server.

Zombies

A zombie is a computer that has been compromised by some malicious hacker. The zombie's software is modified to execute commands under control of the hacker. Usually, the zombie belongs to some unsuspecting owner who may not have the skills to detect that their computer is compromised. Spammers increasingly make use of zombies to send spam because the sent messages appear to come from a legitimate source (i.e., the owner of the zombie). The zombie owner is thus identified as the true source of this spam, which makes it hard for all anti-spam systems to suppress it. While it is possible to try to blacklist these zombie machines, it is often the case that each zombie uses some other email service site (e.g., Google and Yahoo) to actually send the spam. Obviously blacklisting everything from Google and Yahoo is not practical.

Reachback addresses this zombie problem because it identifies each email source down to the level of an individual user. Where a user's computer becomes compromised into a zombie and is used to send spam, since the spam is identified as coming from the individual user, the individual user may be blacklisted, leaving other users of the email service site unaffected. This blacklist information may also be fed to the email service site to help identify zombies.

In an alternate approach, a zombie may use a simple mail relay through an ISP. If the ISP supports Reachback, then the zombie may be properly blacklisted. If the ISP does not support Reachback, then a validation proxy is unable to determine whether a received email from the zombie is valid, and such email messages is to be handled as non-validated mail.

The spammer may also add a Reachback server to the zombie so that any spam sent from that zombie (correctly) appears to come from that zombie machine. However, validation of source does not mean that the source is not spam. If the Reachback URL of the zombie appears on a blacklist, it will still be identified as spam. A zombie sending validated spam still ends up on the blacklist (usually in short order) and all email sent from the zombie is be suppressed.

HTTP Server Hijacking

A malicious hacker may compromise a site's HTTP server. This is less likely if the server implements highly restricted functionality; nevertheless, it is a possibility. This is the same problem as server spoofing and the above described solutions apply.

### DNS Hijacking

A spammer may hijack legitimate DNS entries to point to one of his machines. However, this is a difficult attack to execute and is likely to be much more difficult as DNS security improves. Such an attack is an issue for any anti-spam system and methodology, and is not unique to Reachback.

Receiver Anonymity

The act of using the Reachback URL to access the sender's HTTP server may provide information to the sender's HTTP server. For example, accessing RVI indicates that an email recipient associated with the validation proxy accessing the RVI exists and is reading email. It also tells the sender's HTTP server the IP address of the recipient's machine (where the validation proxy operates on the same machine as the user's email client). This may be considered a significant loss of anonymity compared to the current email system. A spammer may use this information to target the recipient with traditional spam. However, anonymity is retained when Reachback is implemented at a site level, because the site's validation proxy retrieves RVI independently of the legitimacy of a recipient address. Thus, the spammer learns only the IP address of the machine running the validation proxy and does not learn whether any of the recipient addresses are in fact valid.

Blacklist Poisoning

Standard blacklists are subject to poisoning, which means that fraudulent spam messages are sent with legitimate “From” headers in an attempt to fill the blacklist with legitimate senders, thus rendering the blacklist useless. Blacklist poisoning is more difficult with Reachback because the maintainer of the blacklist may retrieve RVI to independently verify that a supposed spam source is the originator of a spam message.

Massive Email Address Space

Any spammer who has access to a very large number of email addresses may potentially defeat any blacklist system by using each email address in turn to send a large amount of spam. After some period, the spammer moves on to use the next available email address. An obvious solution to this is to blacklist the whole sub-domain, or domain, with which all of the email addresses are associated. This works fine when the spammer is using a zombie to send the email messages, but it fails if the spammer is using a large email domain server such as Google and Yahoo, since it is impractical to blacklist the whole domain and affecting legitimate users. Since such large email domain servers typically allow free email registration, a spammer may attempt to use an automated robot to register as many email addresses as needed. Fortunately, these email domains have recognized this problem and have added mechanisms (e.g., requiring the registering person to have a mobile phone address with instant messaging, and using a puzzle system that is difficult for automated systems to solve, but is easy for people to solve) to prevent automated registration.

Massive Use of DNS Names and IP Addresses.

Massive use of DNS names presents a problem that is analogous to the massive email address problem. Under Internet Protocol version 4 (IPv4), it is costly to own more than a few IP addresses. It is possible, though, to define an arbitrary number of DNS names as sub-domains of some primary domain. In practice, the hierarchical nature of DNS names makes it possible to suppress large number of sub-domains by moving up the name hierarchy. This means that while a spammer might have a million names of the form “name.spamdomain.com”, they all will share a common suffix: “spamdomain.com” in this example. The primary domain (“spamdomain.com”) may then be blacklisted to suppress all sub-domains.

Inaccessible HTTP Server

Upon receipt of an email message, a validation proxy attempts to contact an HTTP server based upon a Reachback URL stored the email message. However, validation is not possible when the HTTP server is inaccessible, as is the case when the server is down, its network connectivity has been severed, and/or it is the subject of a denial-of-service (DOS) attack. One solution to the problem of server inaccessibility is to propagate Reachback validation information (e.g., RVI 216) to a plurality of Reachback server sites across the Internet.

Reachback URL caching, described above, is one example of this where Reachback information is propagated to the receiving site and used even if the HTTP server of the sending site is inaccessible. This approach may be extended by allowing other sites to provide the information and providing multiple, redundant Reachback URLs in the message. This is called Reachback delegation. The validation proxy trusts that the information at the delegated site is accurate. A variant of a public key infrastructure (PKI) approach may be used to provide that trust. For example, a well-known and trusted site may provide a service in which it is asked to obtain the Reachback information from some site. The trusted site accesses that information and signs that information plus information about its source. The trusted site uses its own private key, and its corresponding public key is assumed to be well-known. The signed version may then be placed at any convenient location on the web and used as the Reachback URL. The Reachback delegator only attests to the IP address, DNS name, and Reachback information of the source. This is in contrast to other forms of attestation such as PKI or Pretty Good Privacy (PGP) web of trust, where the goal is to attest to some notion of “identity.”

Active Impersonation

Active impersonation, also called “man-in-the-middle”, presents another possible source of spam attacks. In practice this source of attack seems relatively unlikely to be used by spammers because that level of control would more probably be used to convert a site to a zombie. Nevertheless, the effects of such an attack are worth examining.

It can be assumed that the active impersonator has the ability to (1) examine and arbitrarily modify any email being sent to a given receiver and/or (2) examine and arbitrarily modify any email being sent from a given sender. It is assumed that in either scenario, the active impersonator has no other control over the sender and/or receiver. In either scenario, the active impersonator has only a limited set of actions that it may take. The active impersonator may completely replace the email message with one of its own choosing, but that is equivalent to just sending spam. It cannot replace the body of the message without modifying the Reachback URL because the email message content digital signature validation would fail. Replacing the URL (URL spoofing) has already been addressed above. The only effective action the active impersonator may take is to remove the Reachback URL completely. There is no short-term solution for managing email that has no Reachback URL, other than relying upon existing filter-based solutions.

Reachback Variations

In an embodiment, Reachback is implemented using a single secret key instead of a public/private key pair (i.e., public/private key pair 142). Reachback security requires that the single key remain private to the sender and not be revealed to any receiver or potential spammer. The receiver sends a cryptographic message authentication code (MAC) to the source. Operationally, the sender computes the secret key to compute a MAC value for a checksum of the message body. This MAC value is included in the Reachback URL as a parameter. When the sender is contacted using this URL, the sender performs the decryption and returns the unencrypted checksum to the receiver. The receiver compares the unencrypted checksum to a locally re-computed checksum. If they match, then it can be assumed that the email message came from the source specified by the Reachback URL.

When the single secret key is used, local key caching (i.e., use of cache 234 to store the public key and thereby reduce the need to retrieve RVI 216 from server 210 each time) cannot be used. server 210 is accessed for each Reachback email message 252 from email sender 202. Also, a plaintext attach is theoretically possible, where an attacker sends an arbitrary value to the sender's server 210 for decoding. The returned value would then represent the plaintext for the sent value. This attack is easy to defeat by forcing the unencrypted digest into a specific format such as duplicating the digest or adding a constant string to one end or the other. If the unencrypted plaintext does not conform to this format, the sender would not return the plaintext, and may return a fixed value indicating failure to decrypt. Periodic rekeying (i.e., replacing of the secret key) also aids in defeating this attack.

A denial of service attack, in which an attacker repeatedly asks the server to decrypt a signature, is easily defeated by introducing an artificial delay into the decrypting process based on the source of the decryption request. Reachback also offers the possibility of using other validation information in place of keys, as described below.

Email body—The Reachback URL may provide a duplicate of the contents of the email, including selected headers. The content obtained by Reachback can be matched to the email content in the notification. Note that the accuracy of any included headers is irrelevant; it is only important that they match.

Replacement—This is a variant of the Email body validation approach, described above. Instead of comparing the contents of the email body, the email body is discarded and replaced by information content retrieved through Reachback. That is, the Reachback URL allows the validation proxy to retrieve the message content from the sender's Server. This has the advantage that the email message does not actually have to contain the contents at all, which results in smaller messages. This case has two drawbacks. First, such messages cannot be read offline unless validation occurs before being sent to the user. Second, if a non-Reachback user receives such a message, they invoke a web-browser on the Reachback URL to access the mail's contents.

Per-message public key—Unlike the above described method where the Reachback proxy uses one public key per-user or per-site, the Reachback proxy provides a public key for the contents of each sent email. The validation proxy retrieves the public key associated with the particular email message and decrypts that email content. This approach increases the cost of sending the email message (to generate a public/private key pair for each email message sent).

Note that each of the above alternatives may be carried out at the server. This allows the server to determine validity using any method it chooses and without the knowledge of the receiver. These alternative validation mechanisms are less desirable than reaching back for a key because they impose a much larger storage burden on the source site's server. This may be solved by implementing a form of ageing of per-message validation information, such that older validation information may be removed.

These alternatives are not possible with DNS based approaches because they are inherently oriented to domain level validation and are limited in the amount of information they can store in DNS.

RVI may be fetched from may different types of server by encoding one or both of a protocol type and a port within the Reachback URL inserted into the email message by the Reachback proxy. Thus, ports other than typical port 80 and the protocols (e.g., FTP) other than the typical HTTP may be specified within the Reachback URL. The primary requirement for the implemented protocol is that it supports a very large address space and is capable of encoding a form of standardized Reachback URL as described above. HTTP meets this requirement through the URL structure, and FTP may implement it using its file structure.

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall there between.

What is claimed is:

1. A method for generating a Reachback email message, comprising:
intercepting email message addressed to at least one recipient from a sender;
algorithmically determining a Reachback URL based upon email address of the sender;
generating Reachback validation information (RVI) for the email message;
publishing the RVI at a location addressed by the Reachback URL;
adding the Reachback URL to the email message to form the Reachback email message;
digitally signing the Reachback email message using a private key of a public/private key pair; and
sending the Reachback email message to the at least one recipient.

2. The method of claim 1, the step of generating RVI comprising:
including a public key of the public/private key pair in the RVI;
including the email address of the sender within the RVI;
generating a checksum of the public key and the email address of the sender;
encoding the checksum using the private key of the public/private key pair to form a digital signature of the RVI; and
adding the digital signature of the RVI to the RVI.

3. The method of claim 2, the step of digitally signing the Reachback email message comprising:
generating a content checksum of the Reachback email message contents;
encoding the content checksum using the private key to form a content digital signature; and
adding the content digital signature to the Reachback email message.

4. The method of claim 2, further comprising generating the public/private key pair.

5. The method of claim 1, wherein the steps of algorithmically determining, generating RVI, and publishing are performed once for each sender email address.

6. The method of claim 5, wherein the steps of algorithmically determining, generating RVI, and publishing are performed when a new public-private key pair is desired by the sender.

7. A method for validating a Reachback email message, comprising:
intercepting the Reachback email message prior to delivery to an email client of a recipient of the Reachback email message;
retrieving Reachback validation information (RVI) based upon a Reachback URL included within the Reachback email message, the RVI including a public key of a public/private key pair, a sender email address of the Reachback email message, and a digital signature of the RVI;
validating the RVI based upon the digital signature of the RVI and the public key;
algorithmically validating, if the RVI is valid, the Reachback URL using the sender email address;
validating, if the RVI is valid and the Reachback URL is valid, the Reachback email message contents based upon a content digital signature within the Reachback email message and the public key;
storing a valid indication in the Reachback email message if the RVI, the Reachback URL and the Reachback email message contents are valid; and
storing a non-validated indication in the Reachback email message if any one of the RVI, the Reachback URL and the Reachback email message contents are not valid.

8. The method of claim 7, the step of validating the RVI comprising:
generating a checksum of the public key and the sender email address of the Reachback email message;
decoding a sender checksum from the digital signature of the RVI using the public key; and
comparing the sender checksum to the checksum, the RVI being valid if the sender checksum and the checksum match.

9. The method of claim 7, the step of retrieving comprising retrieving the RVI from a server at an address defined by the Reachback URL.

10. The method of claim 9, further comprising storing, in a local cache, the RVI in association with the Reachback URL.

11. The method of claim 10, the step of retrieving comprising retrieving the RVI from the local cache based upon the Reachback URL.

12. The method of claim 7, further comprising marking the Reachback email message as not spam if the Reachback URL is found in a whitelist.

13. The method of claim 7, further comprising, marking the Reachback email message as spam if the Reachback URL is not found in a whitelist and the Reachback URL is found in a blacklist.

14. A system for generating a Reachback email message, comprising:
a Reachback proxy for intercepting an email message from a sender, the Reachback proxy algorithmically determining a Reachback URL from an email address of the sender, adding the Reachback URL to the email message to form the Reachback email message, digitally signing the Reachback email message using a private key of a public/private key pair, and sending the Reachback email message to at least one recipient; and
a server for publishing Reachback validation information (RVI) at a location addressed by the Reachback URL, the RVI comprising a public key of the public/private key pair, a Reachback sender email address, and a digital signature of the RVI.

15. The system of claim 14, wherein the server is an HTTP server.

16. A system for verifying a Reachback URL of a Reachback email message, comprising:
a server for publishing Reachback validation information (RVI) on a website addressed by the Reachback URL, the RVI comprising a public key of a public/private key pair, a Reachback sender email address, and a digital signature; and
a validation proxy for intercepting the Reachback email message before delivery to at least one email client, the validation proxy retrieving the RVI from the website and decoding the digital signature using the public key to validate the RVI and then algorithmically validating the Reachback sender email address to the Reachback URL to determine validity of the Reachback sender email address, the validation proxy storing the Reachback sender email address and a validated indication in the Reachback email message to form a validated Reachback email message if the Reachback sender email address is valid, otherwise storing a non-validated indication in the validated Reachback email message, the validation proxy then sending the validated Reachback email message to the at least one email client.

17. The system of claim 16, further comprising a cache, accessible by the validation proxy, for storing Reachback URLs and the public key of the associated RVI, the validation proxy retrieving the public key from the cache and not the server if the Reachback URL of the received Reachback email message is located within the cache, and the validation proxy storing, in the cache, the public key of the RVI in association with the Reachback URL when the RVI is retrieved from the server.

18. The system of claim 16, wherein the server is an HTTP server.

19. A Reachback email system, comprising:
a Reachback proxy for intercepting a sent email message from an email client, the Reachback proxy algorithmically determining a first Reachback URL from an email address of the email client, adding the first Reachback URL to the sent email message to form a sent Reachback email message, digitally signing the sent Reachback email message using a private key of a public/private key pair, and sending the sent Reachback email message to at least one recipient;
a server for publishing Reachback validation information (RVI) accessible by the at least one recipient using the first Reachback URL, the RVI comprising a public key of the public/private key pair, the email address, and a digital signature of the RVI generated using the private key; and
a validation proxy for intercepting a received Reachback email message before delivery to the email client, the validation proxy retrieving RVI for the received Reachback email message using a second Reachback URL stored within the received Reachback email message, decoding a digital signature of the RVI using a public key stored in the RVI to validate the RVI, and then algorithmically validating the second Reachback URL with an email address of the RVI, the validation proxy providing an indication of the Reachback email message validation and delivering the received Reachback email message to the email client.

20. The system of claim 19, further comprising:
a cache, accessible by the validation proxy, for storing the second Reachback URL and at least the public key of the RVI, the validation proxy utilizing the public key associated with the second Reachback URL for subsequently received Reachback email messages containing the Reachback URL.

21. An email validation system, comprising:
means for algorithmically determining, at a first location, a Reachback URL for an email message sent to at least one recipient;
means for adding, at the first location, the Reachback URL to the email message and digitally signing the email message content;
means for publishing, at the first location, Reachback validation information (RVI) accessible by the at least one recipient based upon the Reachback URL;
means for retrieving, at a second location, the RVI based upon the Reachback URL stored in the email message;
means for validating the RVI, the email message content, and the Reachback URL; and
means for indicating a validation status of the email message.

22. The email validation system of claim 21, further comprising means for caching at least part of each retrieved RVI in association with the Reachback URL such that RVI need not be retrieved and validated for subsequently received email messages having the same Reachback URL.

23. A software product comprising instructions, stored on computer-readable media, wherein the instructions, when executed by a computer, perform steps for sending and receiving validated email messages, comprising:
instructions for algorithmically determining, at a first location, a Reachback URL for an email message sent to at least one recipient;
instructions for adding, at the first location, the Reachback URL to the email message and digitally signing the email message content;
instructions for publishing, at the first location, Reachback validation information (RVI) accessible by the at least one recipient based upon the Reachback URL;
instructions for retrieving, at a second location, the RVI based upon the Reachback URL stored in the email message;
instructions for validating the RVI, the email message content, and the Reachback URL; and
instructions for indicating a validation status of the email message.

24. The software product of claim 23, further comprising instructions for caching at least part of each retrieved RVI in association with the Reachback URL such that RVI need not be retrieved and validated for subsequently received email messages having the same Reachback URL.
